(19) United States
(12) Patent Application Publication
(10) Pub. No.: US 2012/0065914 A1
(43) Pub. Date: Mar. 15, 2012

(54) OPTICAL DETECTION SYSTEM, ELECTRONIC DEVICE AND PROGRAM

(75) Inventor: Kanechika KIYOSE, Matsumoto (JP)

(73) Assignee: SEIKO EPSON CORPORATION, Tokyo (JP)

(21) Appl. No.: 13/225,958

(22) Filed: Sep. 6, 2011

(30) Foreign Application Priority Data
Sep. 13, 2010 (JP) 2010-204018

(51) Int. Cl. G06F 19/00; G01B 11/14

(52) U.S. Cl. 702/95; 356/614

(57) ABSTRACT

An optical detection system includes: a coordinate information detecting section which detects coordinate information of an object on the basis of a light reception result of reflection light obtained by reflecting irradiation light from the object; and a calibrating section which performs a calibration process for the coordinate information. The coordinate information detecting section detects at least Z coordinate information which is the coordinate information in a Z direction in a case where a detection area which is an area where the object is detected is set in a target surface along an X-Y plane, and the calibrating section performs the calibration process for the Z coordinate information.

This application claims priority to Japanese Patent Application No. 2010-204018, filed Sep. 13, 2010 which is expressly incorporated by reference herein in its entirety.

### BACKGROUND

1. Technical Field

The present invention relates to an optical detection system, an electronic device, and a computer program.

2. Related Art

In recent electronic devices such as mobile phones, personal computers, car navigation devices, ticket machines, and bank terminals, a display apparatus has been used having a position detection function in which a touch panel is disposed on a front surface of a display section. In the display apparatus, a user can input information while referring to an image displayed on the display section and pointing to an icon in the displayed image. For position detection using the touch panel, there are known panels, such as a resistive touch panel and a capacitive touch panel.

However, in the touch panel discussed above, since it is necessary to use a finger for touching a screen, the screen may be smudged and damaged. Further, it is difficult to perform a hovering operation in conventional touch panels. The hovering operation means that a user does not execute any command by touching the screen; but the user can move a cursor displayed on the screen. Specifically, it is difficult to perform the hovering operation when the finger is in proximity to the screen without actually touching the screen.

Meanwhile, in a projection display apparatus (projector) or a display apparatus for digital signage, since its display area is wide compared with a display apparatus such as a mobile phone or a personal computer, it is difficult to realize the position detection function by using a resistive or capacitive touch panel as described above. As a position detection device for use in the projection display apparatus in the related art, there are known techniques as disclosed in JP-A-11-345085 and JP-A-2001-142643, for example. However, since the system becomes large-sized, it is difficult to detect the distance between a display surface (screen) and an object. Further, it is difficult to give an instruction by a hovering operation.

### SUMMARY

An advantage of some aspects of the invention is that it provides an optical detection system, an electronic device and a computer program which can detect coordination information on an object, perform a calibration process and give an operation instruction such as a command or data input corresponding to the coordinate information.

An aspect of the invention is directed to an optical detection system including: a coordinate information detecting section that detects coordinate information on an object on the basis of a light reception result of reflection light obtained by reflecting irradiation light from the object; and a calibrating section that performs a calibration process for the coordinate information. Here, the coordinate information detecting section detects at least Z coordinate information which is the coordinate information in a Z direction in a case where a detection area which is an area where the object is detected is set in a target surface along an X-Y plane, and the calibrating section performs the calibration process for the Z coordinate information.

With this configuration, it is possible to detect at least the Z coordinate information on the object on the basis of the light reception result of the reflection light from the object. Thus, it is possible to match the Z coordinate information on the object with an operation instruction such as a command or data input. Further, since the calibration process can be performed for the Z coordinate information, it is possible to calibrate the Z coordinate range corresponding thereto according to a usage status.

In the optical detection system, the calibrating section may perform the calibration process for the Z coordinate information on the basis of the light reception result in a case where the object is in a Z coordinate range for calibration, at the time of calibration.

With this configuration, it is possible to perform the calibration process by detecting the object disposed in the Z coordinate position for calibration.

In the optical detection system, the calibrating section may perform, in a case where a predetermined operation instruction is given in a period when the object is present in a predetermined Z coordinate range, the calibration process for the predetermined Z coordinate range corresponding to the predetermined operation instruction.

With this configuration, it is possible to detect the Z coordinate information on the object, and to match the Z coordinate information with information on the operation instruction. As a result, it is possible to give the operation instruction according to the Z coordinate position of the object.

In the optical detection system, the calibrating section may perform the calibration process for a threshold in the Z coordinate in a hovering operation.

With this configuration, it is possible to appropriately set the threshold in the Z coordinate in the hovering operation. Thus, a user can set a threshold in the Z coordinate suitable for his or her operation.

In the optical detection system, the calibrating section may perform, in a case where it is determined that a fixed operation is performed when a Z coordinate position of the object is equal to or less than Z1 (Z1 is a real number), and that the hovering operation is performed when the Z coordinate position of the object is larger than Z1 and is equal to or less than Z2 (Z2 is a real number satisfying Z2>Z1), the calibration process for the Z coordinate position Z1 and the Z coordinate position Z2.

With this configuration, it is possible to give an operation instruction such as a hovering operation or a fixed operation according to the Z coordinate position of the object. Further, it is possible to perform the calibration process for the threshold of the Z coordinate for determining whether the hovering operation or the fixed operation is performed, and thus, the user can set a threshold in the Z coordinate suitable for his or her operation.

In the optical detection system, the optical detection system may further include a stop instructing section which gives an instruction to stop the object in the Z coordinate position for calibration at the time of calibration, and the calibrating section may perform the calibration process after the stop instruction is given by the stop instructing section.

With this configuration, it is possible to perform the calibration process by stopping the object in the Z coordinate position for calibration.

In the optical detection system, the stop instructing section may give a first stop instruction for the calibration process for the Z coordinate position Z1 and gives a second stop instruction for the calibration process for the Z coordinate position Z2, and the calibrating section may perform the calibration process for the Z coordinate position Z1 after the first stop instruction is given and may perform the calibration process for the Z coordinate position Z2 after the second stop instruction is given.

With this configuration, it is possible to perform the calibration process for Z1 by stopping the object in the Z coordinate position corresponding to Z1, and to perform the calibration process for Z2 by stopping the object in the Z coordinate position corresponding to Z2.

In the optical detection system, the optical detection system may further include amounting section which causes the optical detection system to be mounted to an information processing apparatus, and the calibrating section may perform the calibration process as electric power is supplied from the information processing apparatus.

With this configuration, since the optical detection system can be mounted to the information processing apparatus to perform the calibration process, it is possible to give the information processing apparatus an operation instruction such as a hovering operation or a fixed operation according to the Z coordinate position of the object. As a result, it is possible to give an operation instruction with a finger tip or a pen by mounting the optical detection system to the information processing apparatus having no input means such as a touch panel.

In the optical detection system, the detection area maybe set along a display section of the information processing apparatus.

With this configuration, it is possible to give an operation instruction such as a hovering operation or a fixed operation according to the distance between the object and the display section.

In the optical detection system, the optical detection system may further include a display instructing section which gives an instruction to display a calibration screen on the display section.

With this configuration, it is possible to perform the calibration process according to the calibration screen displayed on the display section.

In the optical detection system, the optical detection system may further include a light irradiating section which emits the irradiation light to the detection area; and a light receiving section which receives the reflection light.

With this configuration, it is possible for the light receiving section to receive the reflection light obtained by reflecting the irradiation light emitted from the light irradiating section from the object, and to detect the coordinate information on the object on the basis of the light reception result.

In the optical detection system, the light receiving section may include a plurality of light receiving units, the plurality of light receiving units may be arranged in positions having different heights in the Z direction, and the coordinate information detecting section may detect the Z coordinate information on the basis of the light reception result of each of the plurality of light receiving units.

With this configuration, it is possible for each light receiving unit to receive the reflection light from the object which is present in the different Z coordinate position, and thus, it is possible to detect the Z coordinate information of the object.

Another aspect of the invention is directed to an electronic device which includes any one of the optical detection systems as described above.

Still another aspect of the invention is directed to a computer readable memory storing a computer program executable by a processor for controlling an optical detection system, the computer program allowing the processor to perform the processing including: a coordinate information detecting procedure that detects coordinate information on an object on the basis of a light reception result of reflection light obtained by reflecting irradiation light from the object; a calibrating procedure that performs a calibration process for the coordinate information; and a stop instructing procedure that gives an instruction to stop the object in the Z coordinate position for calibration at the time of calibration, wherein the coordinate information detecting procedure detects at least Z coordinate information which is the coordinate information in a Z direction in a case where a detection area which is an area where the object is detected is set in a target surface along an X-Y plane, and the calibrating procedure performs the calibration process for the Z coordinate information after the stop instruction is given by the stop instructing procedure.

### BRIEF DESCRIPTION OF THE DRAWINGS

The invention will be described with reference to the accompanying drawings, wherein like numbers reference like elements.

FIGS. 1A and 1B illustrate an example of a basic configuration of an optical detection system.

FIG. 2 illustrates an example of a specific configuration of a light receiving section.

FIG. 3 illustrates a modified example of a light receiving section.

FIGS. 4A and 4B illustrate an example of a configuration of a light receiving unit.

FIG. 5 illustrates an example of a detailed configuration of a light irradiating section.

FIGS. 6A and 6B are diagrams illustrating a method for detecting coordinate information.

FIGS. 7A and 7B illustrate examples of signal waveforms of a light emission control signal.

FIG. 8 illustrates a modified example of a light irradiating section.

FIGS. 9A and 9B illustrate examples of a configuration of an optical detection system including a mounting section.

FIG. 10 illustrates an example of a flow diagram of a calibration process.

FIGS. 11A and 11B illustrate examples of first and second stop instructions.

### DESCRIPTION OF EXEMPLARY EMBODIMENTS

Hereinafter, preferred embodiments of the invention will be described. The embodiments do not unduly limit the content of the invention described in the appended claims, and not all configurations described in these embodiments necessarily serve as essential solving means of the invention.

### 1. Optical Detection System

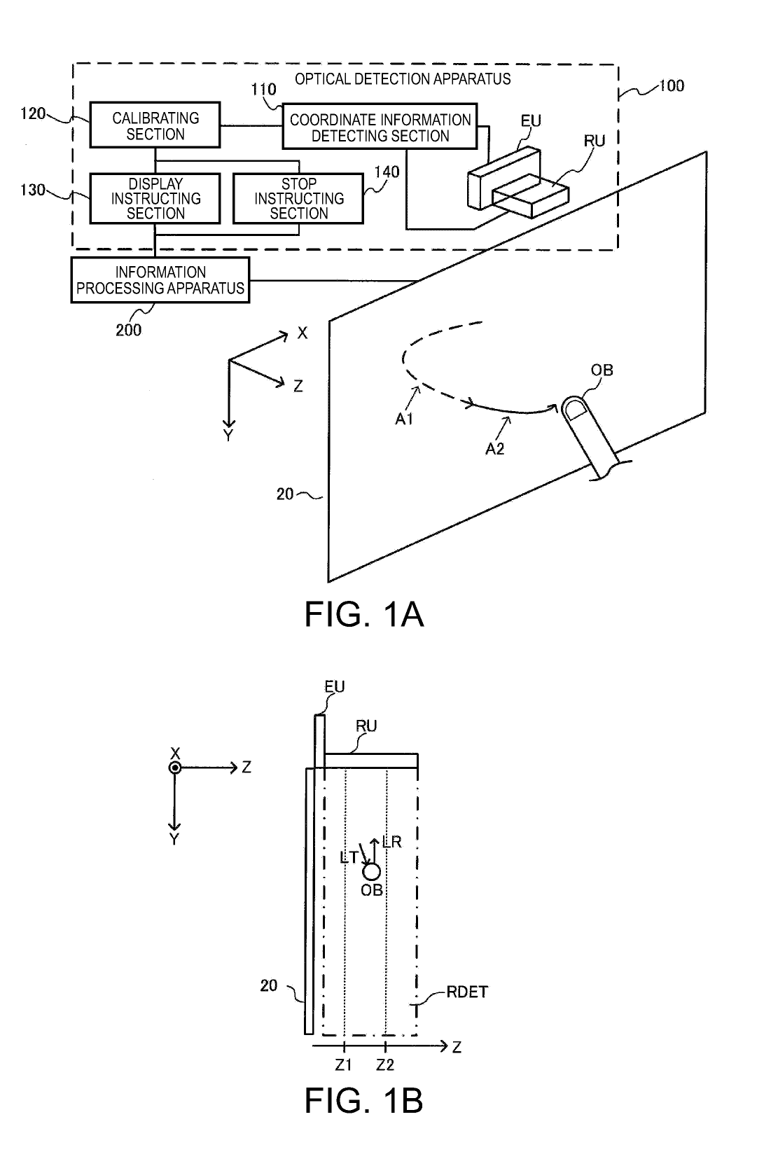

FIG. 1A illustrates an example of a basic configuration of an optical detection system according to the present embodiment. The optical detection system according to this embodiment includes an optical detection apparatus 100 and an information processing apparatus 200. The optical detection apparatus 100 includes a coordinate information detecting section 110, a calibrating section 120, a display instructing section 130, a stop instructing section 140, a light irradiating section EU and a light receiving section RU. FIG. 1B is a diagram illustrating detection of Z coordinate information by the optical detection system according to this embodiment. The optical detection system in this embodiment is not limited to the configuration shown in FIGS. 1A and 1B, but may employ such a variety of modifications that a part of its components is omitted or replaced with a different component, or a different component is added. Further, the optical detection system according to this embodiment may be realized by only the optical detection apparatus 100, or may be realized by both of the optical detection apparatus 100 and the information processing section 200. For example, a partial function of each component such as a calibrating section 120, a display instructing section 130 or a stop instructing section 140 may be realized by the information processing section 200.

The coordinate information detecting section 110 detects coordinate information on an object OB on the basis of a light reception result of reflection light LR obtained by reflecting irradiation light LT from the object OB. Specifically, for example, as shown in FIG. 1B, in a case where a detection area RDET which is an area in which the object OB is detected is set in a target surface along an X-Y plane, the coordinate information detecting section 110 detects at least Z coordinate information which is coordinate information in a Z direction. The coordinate information detecting section 110 may further detect X coordinate information and Y coordinate information on the object OB which is present in the detection area RDET. A method for detecting the coordinate information by the coordinate information detecting section 110 will be described later.

Here, the X-Y plane is a plane along the target surface (display surface) defined by a display section 20. The target surface is a plane which becomes a setting target of the detection area RDET, and includes a display surface of a display of an information processing apparatus, a projection surface of a projection display apparatus, or a display surface in a digital signage.

The detection area RDET is an area (region) in which the object OB is detected. Specifically, the detection area RDET is an area where the light receiving section RU can receive the reflection light LR obtained by reflecting the irradiation light LT from the object OB to detect the object OB. More specifically, the area refers to an area where the light receiving section RU can receive the reflection light LR to detect the object OB and the detection accuracy of an allowable range can be secured.

The calibrating section 120 performs a calibration process for the detected coordinate information. Specifically, the calibrating section 120 performs the calibration process for the Z coordinate information. More specifically, the calibrating section 120 performs the calibration process for the Z coordinate information, on the basis of a light reception result when the object OB is in a Z coordinate range for calibration (for example, in a range defined by Z1 and Z2 in FIG. 1B) during calibration.

Further, in a case where a predetermined operation instruction is given in a period when the object OB is in a predetermined Z coordinate range, the calibrating section 120 performs the calibration process for the predetermined Z coordinate range corresponding to the predetermined operation instruction. Specifically, the calibrating section 120 performs the calibration process for a threshold in the Z coordinate in a hovering operation. More specifically, as shown in FIG. 1B, in a case where it is determined that a fixed operation is performed when a Z coordinate position of the object OB is equal to or less than Z1, and that the hovering operation is performed when the Z coordinate position of the object OB is larger than Z1 and is equal to or less than Z2 (Z1<Z2), the calibrating section 120 performs the calibration process for Z1 and Z2.

The calibration process may be performed by the information processing apparatus 200, instead of the calibrating section 120.

Here, information of the operation instruction relates to an instruction for operating the information processing apparatus 200 (personal computer) in FIG. 1A and corresponds to cursor movement using a mouse or clicking a button. Specifically, when the Z coordinate position of the object OB (finger tip or pen) is larger than Z1 and is equal to or less than Z2, the operation instruction through the finger tip is recognized as the hovering operation. Through this hovering operation, it is possible to move a cursor displayed on a display section 20 (display) (A1 in FIG. 1A). Further, for example, when the Z coordinate position of the object OB is equal to or less than Z1, the operation instruction through the finger tip is recognized as the fixed operation. Through this fixed operation, it is possible to designate a button on a screen to perform a predetermined command, to input handwritten characters, or to perform screen scrolling (A2 in FIG. 1A).

Here, the calibration process is a process of calibrating the coordinate information output from the coordinate information detecting section 110, and specifically is a process of calibrating the threshold (for example, Z1 and Z2) in the Z coordinate for determining whether the operation by the object OB (finger tip) is the hovering operation or the fixed operation.

The display instructing section 130 gives an instruction to display a calibration screen on the display section 20.

The stop instructing section 140 gives an instruction to stop the object OB in the Z coordinate position for calibration (Z1 and Z2 in FIG. 1B) during calibration. The calibrating section 120 performs the calibration process after a stop instruction is given by the stop instructing section 140. More specifically, the stop instructing section 140 gives a first stop instruction for the calibration process for Z1 and a second stop instruction for the calibration process for Z2. Further, the calibrating section 120 performs the calibration process for Z1 after the first stop instruction is given, and performs the calibration process for Z2 after the second stop instruction is given. Details about a flow of the first and second stop instructions and the calibration process will be described later.

The light irradiating section EU emits the irradiation light LT to the detection area RDET. As described later, the light irradiating section EU includes a light source section including a light emitting element such as an LED (light emitting diode) and emits infrared light (near-infrared light which is near a visible light region) by the light source section.

The light receiving section RU receives the reflection light LR obtained by reflecting the irradiation light LT from the object OB. The light receiving section RU may include a plurality of light receiving units PD. The light receiving units PD may include a photodiode or a phototransistor.

The information processing section 200 is, for example, a personal computer (PC). The information processing section 200 displays the calibration screen on the display section (display) 20 on the basis of the instruction of the display instructing section 130. Further, on the basis of the detection result of the coordinate information detecting section 110, a cursor is displayed on the display section 20. When the operation instruction is given according to the Z coordinate information, it is possible to perform the hovering operation and the fixed operation for the information processing section 200 on the basis of the Z coordinate position of the object OB. Further, the information processing apparatus 200 may perform the calibration process.

According to the optical detection system of this embodiment, it is possible to detect the Z coordination information on the object OB and to match the Z coordinate information with the operation instruction information. In this way, a user moves a finger tip to thereby give the instruction such as a hovering operation or a fixed operation to the information processing apparatus 200. Further, since the calibration process of calibrating the threshold (for example, Z1, Z2) for determining whether the operation is the hovering operation or the fixed operation can be performed, the user is able to set the threshold in the Z coordinate for easier operation. Further, since the operation instruction can be given even though a finger tip is not in contact with the screen unlike a touch panel, it is possible to prevent the screen from being smudged or damaged.

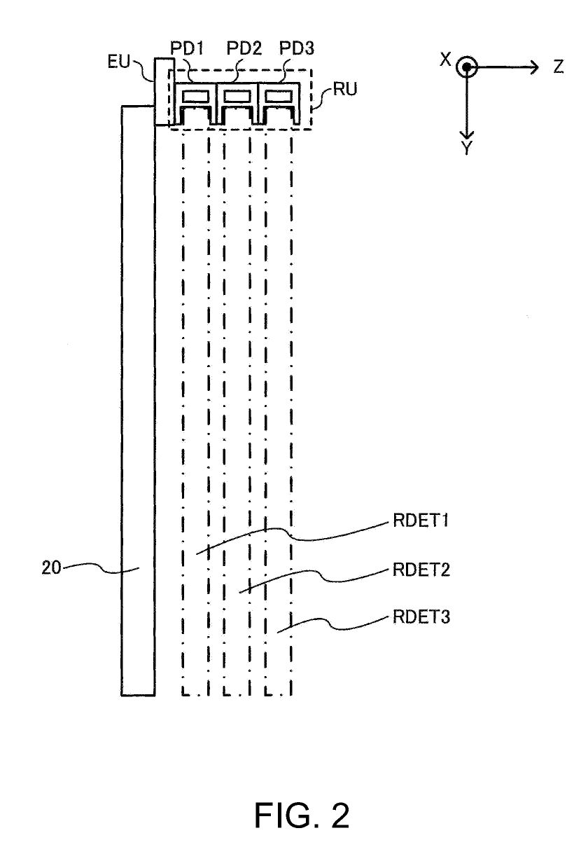

FIG. 2 illustrates an example of a configuration of the light receiving section RU according to this embodiment. In the configuration example in FIG. 2, the light receiving section RU includes three light receiving units PD1 to PD3. The light receiving units PD1 to PD3 are arranged in positions having different heights in the Z direction. The three light receiving units PD1 to PD3 have a slit (incident light control section) for controlling an angle (angle on a Y-Z plane) at which incident light is input, and receives the reflection light LR from the object OB which is present in detection areas RDET1 to REDT3, respectively. For example, the light receiving unit PD1 receives the reflection light LR from the object OB which is present in the detection area RDET1, but does not receive the reflection light LR from the object OB which is present in the other detection areas RDET2 and RDET3. The coordinate information detecting section 110 detects Z coordinate information on the basis of a light reception result of each of the plurality of light receiving units PD1 to PD3. The light irradiating section EU emits the irradiation light LT to the three detection areas RDET1 to RDET3. Further, each of the detection areas RDET1 to RDET3 is an area which is set in the target surface along the X-Y plane.

In this way, it is possible to detect whether the object OB is present in any detection area among the three detection areas RDET1 to RDET3. It is thus possible to detect the Z coordinate information on the object OB. Further, as described above, it is possible to perform the calibration process for matching of the Z coordinate information with the operation instruction information.

The configuration example in FIG. 2 includes three light receiving units, but may include four or more light receiving units. Further, as described later, because the light irradiating section EU emits the irradiation light LT and each of the light receiving units PD1 to PD3 receives the reflection light LR from the object OB, it is possible to detect the X coordinate information and the Y coordinate information on the object OB.

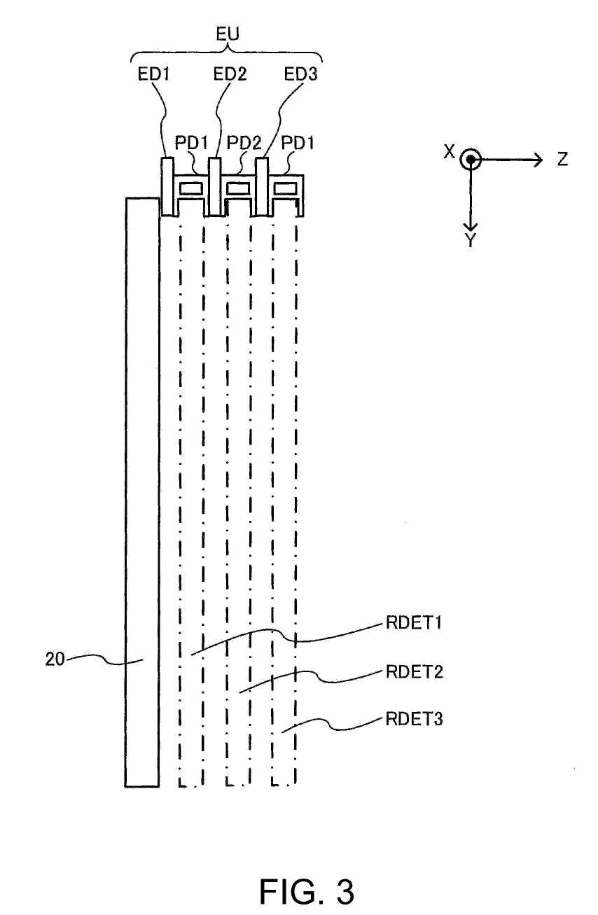

FIG. 3 illustrates a modified example of the light receiving section RU according to this embodiment. In the modified example in FIG. 3, the light irradiating section EU includes three light irradiating units ED1 to ED3. The light irradiating units ED1 to ED3 emit the irradiation light LT to the corresponding detection areas RDET1 to RDET3. For example, when the object OB is present in the detection area RDET1, the irradiation light from the light irradiating unit ED1 is reflected from the object OB. The reflection light is then received by the light receiving unit PD1.

In this way, it is possible to detect a location of a detection area where the object OB is present among the three detection areas RDET1 to RDET3. It is thus possible to detect the Z coordinate information on the object OB and to perform the calibration process. Further, as one light irradiating unit is installed to correspond to one detection area, it is possible to improve the detection accuracy of the Z coordinate information, thereby making it possible to perform the calibration process with high accuracy.

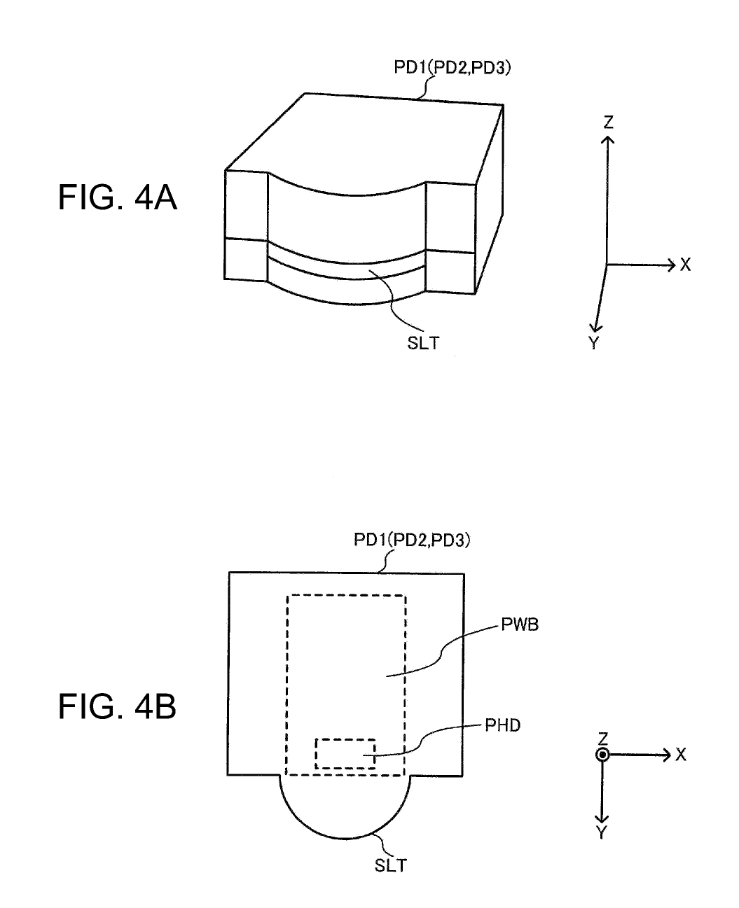

FIGS. 4A and 4B show an example of a configuration of the light receiving units PD1 to PD3 with a slit SLT (incident light control section). As shown in FIG. 4A, the slit SLT is disposed in front of a light receiving element PHD to control incident light. The slit SLT is disposed along the X-Y plane to thereby control an angle of the incident light in a Z direction. The light receiving units PD1 to PD3 can receive the incident light at a predetermined angle defined by a slit width of the slit SLT.

FIG. 4B is a plan view of the light receiving units having the slit SLT, when seen from above. A wiring substrate PWB is disposed in a case made of aluminum. The light receiving element PHD is mounted on the wiring substrate PWB.

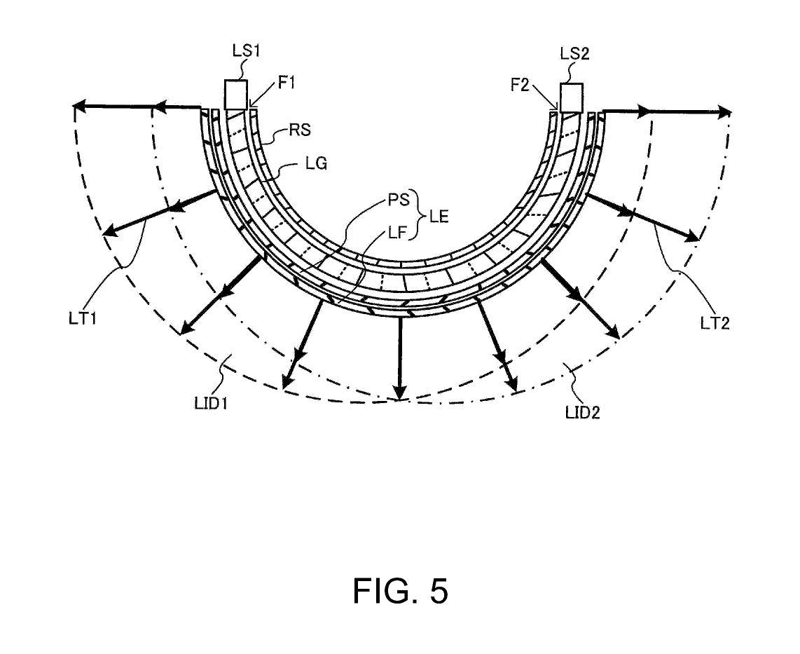

FIG. 5 illustrates an example of a detailed configuration of the light irradiating section EU according to this embodiment. The light irradiating section EU of the configuration example in FIG. 5 includes light source sections LS1 and LS2, a light guide LG, and an irradiation direction setting section LE, and further includes a reflection sheet RS. The irradiation direction setting section LE includes a prism sheet PS and a louver film LF. The light irradiating section EU according to this embodiment is not limited to the configuration shown in FIG. 5, but may employ such a variety of modifications. A part of its components is omitted or replaced with a different component, or a different component is added.

The light source sections LS1 and LS2 emit light and have a light emitting element such as an LED (light emitting diode). The light emitting sections LS1 and LS2 emit infrared light (near infrared light which is near a visible light region). It is preferable that the light emitted by the light source sections LS1 and LS2 have a wavelength band which is efficiently reflected from an object such as a user's finger or a touch pen or a wavelength band which is not noticeably contained in ambient light. Specifically, the light is infrared light having a wavelength of about 850 nm that has high reflectance to a surface of a human body. The light is infrared light having a wavelength of about 950 nm that is not remarkably contained in ambient light.

The light source section LS1 is formed on one end side of the light guide LG as indicated by F1 in FIG. 5. Further, the second light source section LS2 is formed on the other end side of the light guide LG as indicated by F2. Further, the light source section LS1 emits light to a light entering surface of one end side (F1) of the light guide LG to emit irradiation light LT1, so as to form (set) a first irradiation light intensity distribution LID1 in the detection area of the object. Meanwhile, the light source section LS2 emits second light to a light entering surface of the other end side (F2) of the light guide LG to emit second irradiation light LT2, so as to form a second irradiation light intensity distribution LID2 which is different in intensity distribution from the first irradiation light intensity distribution LID1 in the detection area. In this way, the light irradiating section EU can emit irradiation light having different intensity distributions according to positions in the detection area RDET.

The light guide LG (light guiding member) guides the light emitted by the light source sections LS1 and LS2. The light guide LG has a curve shape to guide the light from the light source sections LS1 and LS2 along a curved light guide path. Specifically, as shown in FIG. 5, the guide light LG is formed in an arc shape. In FIG. 5, the arc of the light guide LG has a central angle of 180°, but may have a central angle smaller than 180°. The light guide LG is formed by a transparent resin member such as an acryl resin or polycarbonate.

On at least one side of an outer circumferential side and an inner circumferential side of the light guide LG is performed a working process for adjusting the light emission efficiency of the light from the light guide LG. As the working process, a variety of methods such as silk printing for printing reflection dots, stamping or injection molding for forming concaves and convexes, or groove forming may be employed.

The irradiation direction setting section LE realized by the prism sheet PS and the louver film LF is disposed on the outer circumferential side of the light guide LG. The irradiation direction setting section LE receives the light emitted from the outer circumferential side (outer circumferential surface) of the light guide LG. Further, the irradiation direction setting section LE emits the irradiation light LT1 or LT2 of which the irradiation direction is set in a direction toward the outer circumferential side of the light guide LG having the curved shape (arc shape) from the inner circumferential side thereof. That is, the direction of the light emitted from the outer circumferential side of the light guide LG is set (controlled) in the irradiation direction along a normal direction (radial direction) of the light guide LG. Thus, in the direction toward the outer circumferential side from the inner circumferential side of the light guide LG, the irradiation light LT1 or LT2 is emitted in a radial shape.

Setting of the irradiation direction of the irradiation light LT1 or LT2 is realized by the prism sheet PS or the louver film LF of the irradiation direction setting section LE. For example, the prism sheet PS raises up the direction of the light emitted at a low visibility from the outer circumferential side of the light guide LG in the normal direction so that a peak of a light output characteristic is set in the normal direction. Further, the louver film LF blocks (cuts) the light (low visibility light) in a direction other than the normal direction.

In this way, according to the light irradiating section EU of this embodiment, the light source section LS1 or LS2 is disposed in both ends of the light guide LG to alternately turn on the light source section LS1 or LS2, to thereby form two irradiation light intensity distributions. It is possible to alternately form the irradiation light intensity distribution LID1 in which the intensity on one end side of the light guide LG increases and the irradiation light intensity distribution LID2 in which the intensity on the other end side of the light guide LG increases.

By forming the above-described irradiation light intensity distributions LID1 and LID2 and by receiving reflection light from the object obtained by the irradiation light having these intensity distributions, it is possible to detect the object with high accuracy and to minimally suppress the influence of ambient light. Therefore, it is possible to cancel out an infrared component included in the ambient light. It is thus possible to minimally suppress the bad influence of the infrared component on the detection of the object.

### 2. Method for Detecting Coordinate Information

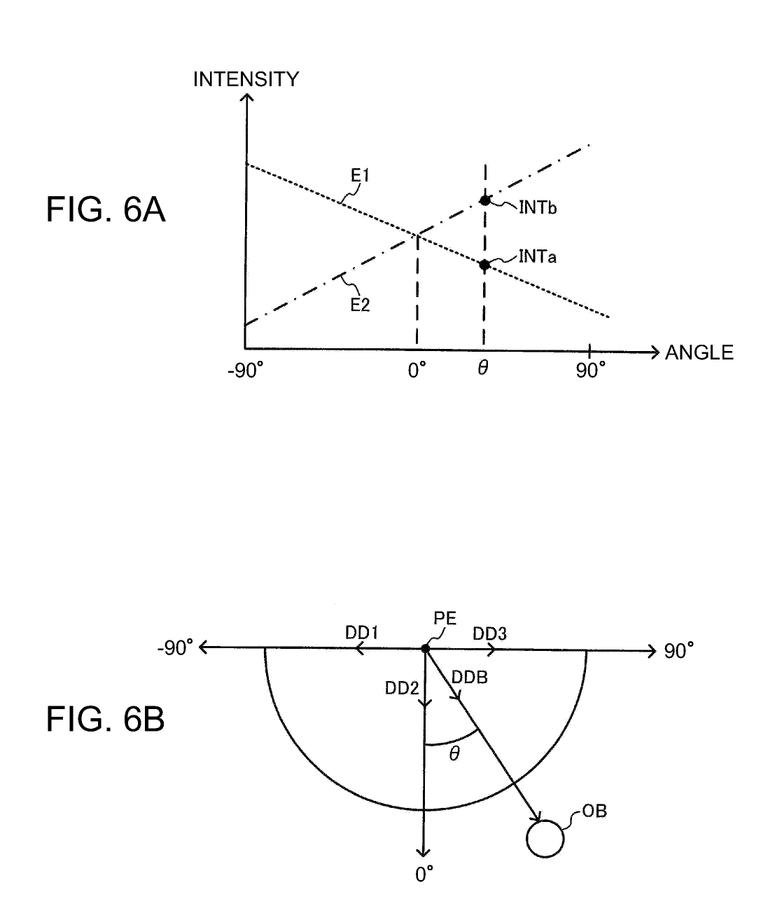

FIGS. 6A and 6B are diagrams illustrating a method for detecting coordinate information by the optical detection system according to this embodiment.

E1 in FIG. 6A illustrates the relationship between an angle of the irradiation light LT1 in the irradiation direction and the intensity of the irradiation light LT1 at the angle thereof, in the irradiation light intensity distribution LID1 in FIG. 5. In E1 in FIG. 6A, the intensity becomes the highest when the irradiation direction is a DD1 direction (left direction) in FIG. 6B. On the other hand, when the irradiation direction is a DD3 direction (right direction), the intensity becomes the lowest. An intermediate intensity is obtained in a DD2 direction. Specifically, with reference to an angle change from the DD1 direction to the DD3 direction, the intensity of the irradiation light uniformly decreases, for example, linearly changes. In FIG. 6B, an arc shaped center position of the light guide LG is disposed in an arrangement position PE of the light irradiating section EU.

Further, E2 in FIG. 6A illustrates the relationship between an angle of the irradiation light LT2 in the irradiation direction and the intensity of the irradiation light LT2 at the angle thereof, in the irradiation light intensity distribution LID2 in FIG. 5. In E2 in FIG. 6A, the intensity becomes the highest when the irradiation direction is the DD3 direction in FIG. 6B. On the other hand, when the irradiation direction is the DD1 direction, the intensity becomes the lowest, and an intermediate intensity is obtained in the DD2 direction. Specifically, with reference to an angle change from the DD3 direction to the DD1 direction, the intensity of the irradiation light uniformly decreases, for example, linearly changes. In FIG. 6A, the relationship between the angle and the intensity in the irradiation direction is the linear relationship, but the present embodiment is not limited thereto, and it may have a hyperbolic curve relationship.

Further, as shown in FIG. 6B, it is assumed that the object OB is present in a direction DDB of an angle θ. Then, in a case where the irradiation light intensity distribution LID1 is formed as the light source section LS1 emits light (in the case of E1), the intensity in the position of the object OB which is present in the DDB direction (angle θ) becomes INTa, as shown in FIG. 6A. On the other hand, in a case where the irradiation light intensity distribution LID2 is formed as the light source section LS2 emits light (in the case of E2), the intensity in the position of the object OB which is present in the DDB direction becomes INTb.

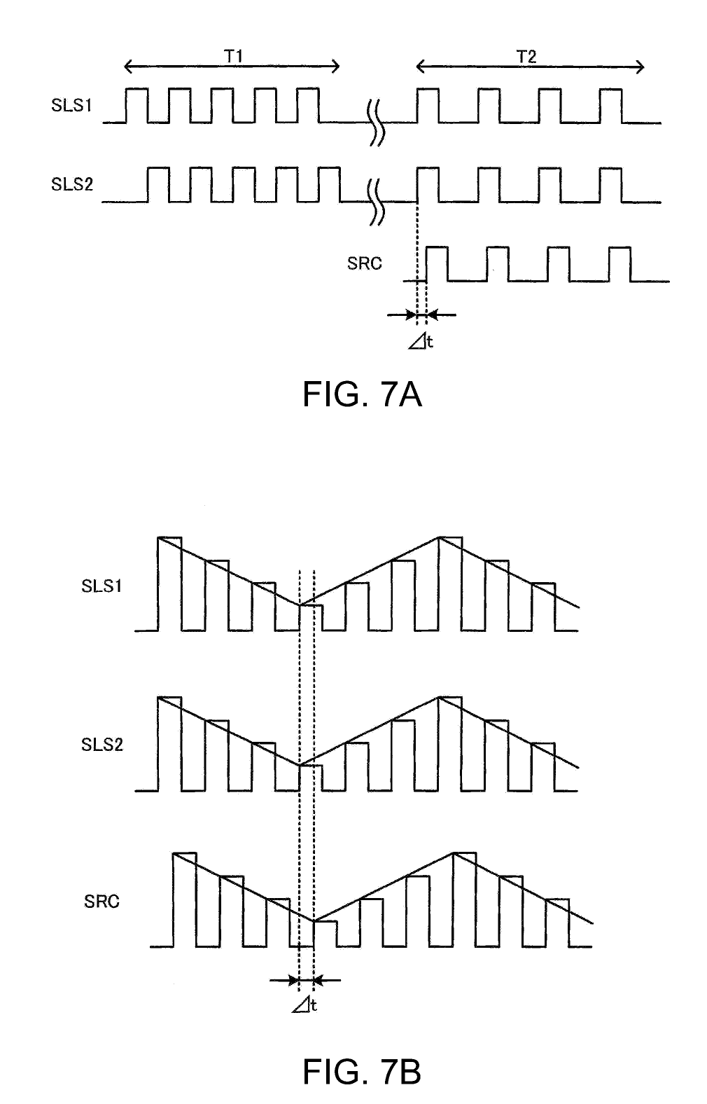

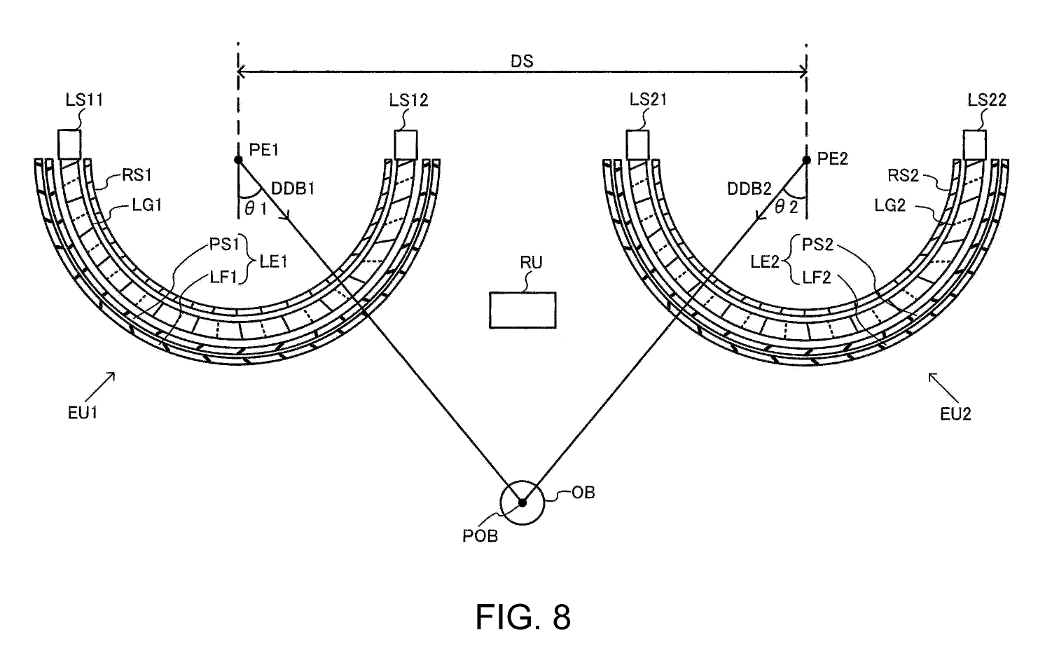

Accordingly, by calculating the relationship between the intensities INTa and INTb, it is possible to specify the DDB direction (angle θ) in which the object OB is positioned. Further, by calculating the distance of the object OB from the arrangement position PE of the optical detection apparatus using the methods shown in FIGS. 7A and 7B, it is possible to specify the position of the object OB on the basis of the calculated distance and the DDB direction. Alternatively, as shown in FIG. 8 which will be described later, by installing two light irradiating units EU1 and EU2 as the irradiating section EU and by calculating the directions DDB1 (θ1) and DDB2 (θ2) of the object OB with regard to the respective light irradiating units EU1 and EU2, it is possible to specify the position of the object OB using the directions DDB1 and DDB2 and the distance DS between the irradiation units EU1 and EU2.

In order to obtain the relationship between the above-described intensities INTa and INTb, in this embodiment, the light receiving section RU receives the reflection light (first reflection light) of the object OB when the irradiation light intensity distribution LID1 is formed. If the detected light amount of the reflection light is represented as Ga, Ga corresponds to the intensity INTa. Further, the light receiving section RU receives the reflection light (second reflection light) of the object OB when the irradiation light intensity distribution LID2 is formed. If the detected light amount of the reflection light is represented as Gb, Gb corresponds to the intensity INTb. Accordingly, if the relationship between the detected light amounts Ga and Gb are calculated, the relationship between the intensities INTa and INTb is calculated. Thus, it is possible to calculate the DDB direction where the object OB is disposed.

If a control amount (electric current amount), a conversion coefficient and an emitted light amount in the light source section LS1 are respectively represented as Ia, k and Ea, and if a control amount (electric current amount), a conversion coefficient and an emitted light amount in the light source section LS2 are respectively represented as Ib, k and Eb, the following expressions (1) and (2) are established.

Ea=k×Ia (1)

Eb=k×Ib (2)

Further, if an attenuation coefficient of the light (first light) from the light source section LS1 is represented as fa and the detected light amount of the reflection light (first reflection light) corresponding to the light is represented Ga, and if an attenuation coefficient of the light (second light) from the light source section LS2 is represented as fb and the detected light amount of the reflection light (second reflection light) corresponding to the light is represented as Gb, the following expressions (3) and (4) are established.

Ga=fa×Ea=fa×k×Ia (3)

Gb=fb×Eb=fb×k×Ib (4)

Accordingly, the ratio between the detected light amounts Ga and Gb is expressed as the following expression (5).

Ga/Gb=(fa/fb)×(Ia/Ib) (5)

Here, Ga/Gb can be specified from the light reception result in the light receiving section RU, and Ia/Ib can be specified from the control amount of the light irradiating section EU. Further, the intensities INTa and INTb and the attenuation coefficients fa and fb in FIG. 6A have a unique relationship. For example, when the values of the attenuation coefficients fa and fb decrease and thus the attenuation amounts increase, it means that the intensities INTa and INTb decrease. On the other hand, when the values of the attenuation coefficients fa and fb increase and thus the attenuation amounts decrease, it means that the intensities INTa and INTb increase. Accordingly, as the ratio of the attenuation coefficients fa/fb is calculated from the expression (5), it is possible to calculate the direction and position of the object.

More specifically, in order to fix one control amount Ia to Im and to obtain the ratio Ga/Gb of the detected light amounts as 1, the other control amount Ib is controlled. For example, the light source sections LS1 and LS2 are controlled to be alternately turned on in opposite phases; and the wavelengths of the detected light amounts are analyzed. The other control amount Ib is then controlled so that the detected wavelengths are not observed (Ga/Gb=1). Further, the ratio of the attenuation coefficients fa/fb is calculated from the other control amount Ib=Im×(fa/fb) at that time, to thereby calculate the direction and position of the object.

Further, as shown in the following expressions (6) and (7), the control may be performed so that Ga/Gb=1 and the sum of the control amounts Ia and Ib is constant.

Ga/Gb=1 (6)

Im=Ia+Ib (7)

If the expressions (6) and (7) are substituted into the expression (5), the following expression (8) is established.

Ga/Gb=1=(fa/fb)×(Ia/Ib)=(fa/fb)×{(Im−Ib)/Ib} (8)

Ib is expressed as the following expression (9) from the above expression (8).

Ib={fa/(fa+fb)}×Im (9)

Here, if fa/(fa+fb) is represented as α, the expression (9) is expressed as the following expression (10), and the ratio of the attenuation coefficients fa/fb is expressed as the following expression (11) using α.

Ib=α×Im (10)

fa/fb=α/(1−α) (11)

Accordingly, if the control is performed so that Ga/Gb=1 and the sum of Ia and Ib becomes the constant value Im, α is calculated from the Ib and Im at that time by the above expression (10). If the calculated α is substituted into the expression (11), the ratio of the attenuation coefficients fa/fb can be obtained. Thus, it is possible to calculate the direction and position of the object. Further, as the control is performed so that Ga/Gb=1 and the sum of Ia and Ib becomes constant, it is possible to reduce the influence of ambient light, thereby enhancing the detection accuracy.

Now, an example of a method for detecting the coordinate information of the object using the optical detection system according to this embodiment will be described. FIG. 7A is a signal waveform example for light emission control of the light source sections LS1 and LS2. A signal SLS1 is a light emission control signal of the light source section LS1 and a signal SLS2 is a light emission control signal of the light source section LS2. The signals SLS1 and SLS2 have opposite phases each other. Further, a signal SRC is a light receiving signal.

For example, the light source section LS1 is turned on (emits light) when the signal SLS1 is at a high level, and is turned off at a low level. Further, the light source section LS2 is turned on (emits light) when the signal SLS2 is at a high level, and is turned off at a low level. Accordingly, during a first period T1 in FIG. 7A, the light source section LS1 and the light source section LS2 are alternately turned on. In the period when the light source section LS1 is turned on, the light source section LS2 is turned off. Thus, the irradiation light intensity distribution LID1 as shown in FIG. 5 is formed. On the other hand, in the period when the light source section LS2 is turned on, the light source section LS1 is turned off. Thus, the irradiation light intensity distribution LID2 as shown in FIG. 5 is formed.

In this way, the coordinate information detecting section 110 controls the light source sections LS1 and LS2 to be alternately turned on (emit light) during the first period T1. Further, in the first period T1, a direction is detected where the object is positioned when seen from the optical detection apparatus (light irradiating section). Specifically, as expressed in the above expressions (6) and (7), the light emitting control is performed in the first period T1 such that Ga/Gb=1 and the sum of the control amounts Ia and Ib becomes constant. Further, as shown in FIG. 6B, the direction DDB where the object OB is disposed is calculated. For example, the ratio of the attenuation coefficients fa/fb is calculated from the expressions (10) and (11), and the direction DDB where the object OB is disposed is calculated by the method described in FIGS. 6A and 6B.

Further, in a second period T2 subsequent to the first period T1, a distance to the object OB (distance in a direction along the DDB direction) is detected on the basis of the light reception result in the light receiving section RU. Further, the position of the object OB is detected on the basis of the detected distance and the direction DDB of the object OB. In FIG. 6B, if the distance to the object OB from the arrangement position PE of the optical detection apparatus and the direction DDB are calculated, it is possible to specify X and Y coordinate positions of the object OB. In this way, by calculating the distance from the time difference between the light emitting timing of the light source and the light receiving timing, and by combining the distance and the angle result, it is possible to specify the position of the object OB.

Specifically, in FIG. 7A, a time Δt to a timing when the light receiving signal SRC becomes active (timing when the reflection light is received) from the light emitting timings of the light source sections LS1 and LS2 by the light emitting control signals SLS1 and SLS2 is calculated. That is, the time Δt until light from the light source sections LS1 and LS2 is reflected from the object OB and is received by the light receiving section RU is detected. As the time Δt is detected, since the speed of light is already known, it is possible to detect the distance to the object OB. By measuring a difference width (time) in a light arrival time and by considering the light speed, the distance is calculated.

Since the light speed is considerably fast, it is difficult to detect the time Δt by calculating a simple difference only using an electric signal. In order to solve such a problem, it is preferable to modulate the light emission control signal as shown in FIG. 7B. Here, FIG. 7B illustrates examples of signal waveforms in which light intensities (electric current amounts) are schematically expressed by amplitudes of the control signals SLS1 and SLS2.

Specifically, in FIG. 7B, the distance is detected by TOF (Time Of Flight) which is a known continuous wave modulation method. In the continuous wave modulation TOF method, continuous light of which the intensity is modulated by a continuous wave of a specific cycle is used. Then, the intensity-modulated light is emitted and the reflection light is received a plurality of times at a time interval shorter than the modulation cycle. Then, the waveform of the reflection light is demodulated and a phase difference between the irradiation light and the reflection light is calculated, to detect the distance. In FIG. 7B, only the light corresponding to one of the control signals SLS1 and SLS2 may be intensity-modulated. Further, waveforms modulated by a continuous triangular wave or sine wave may be employed, instead of clock waveforms as shown in FIG. 7B. Further, the distance may be detected by a pulse modulation TOF method in which pulse light is used as the continuously modulated light. Details of the distance detection method are disclosed in JP-A-2009-8537.

FIG. 8 illustrates a modified example of the light irradiating section EU according to this embodiment. In FIG. 8, the first light irradiating unit EU1 and the second light irradiating unit EU2 are provided as the light irradiating section EU. The first and second light irradiating units EU1 and EU2 are separated by a predetermined distance DS in a direction along a surface of the detection area RDET of the object OB. The first and second light irradiating units EU1 and EU2 are separated by the distance DS along the X axial direction in FIGS. 1A and 1B.

The first light irradiating unit EU1 radially emits first irradiation light which is different in intensity according to an irradiation direction. The second light irradiating unit EU2 radially emits second irradiation light which is different in intensity according to an irradiation direction. The light receiving section RU receives first reflection light obtained by reflecting the first irradiation light from the first light irradiating unit EU1 from the object OB and second reflection light obtained by reflecting the second irradiation light from the second light irradiating unit EU2 from the object OB. Further, the coordinate information detecting section 110 detects a position POB of the object OB on the basis of the light reception result in the light receiving section RU.

Specifically, the coordinate information detecting section 110 detects the direction of the object OB for the first light irradiating unit EU1 as a first direction DDB1 (angle θ1), on the basis of the light reception result of the first reflection light. Further, the coordinate information detecting section 110 detects the direction of the object OB for the second light irradiating unit EU2 as a second direction DDB2 (angle θ2), on the basis of the light reception result of the second reflection light. Further, the position POB of the object OB is calculated on the basis of the detected first and second directions DDB1 (θ1) and DDB2 (θ2) and the distance DS between the first and second light irradiating units EU1 and EU2.

According to the modified example in FIG. 8, as shown in FIGS. 7A and 7B, even though the distance between the optical detection apparatus and the object OB is not detected, it is possible to detect the position POB of the object OB.

### 3. Optical Detection System Including a Mounting Section

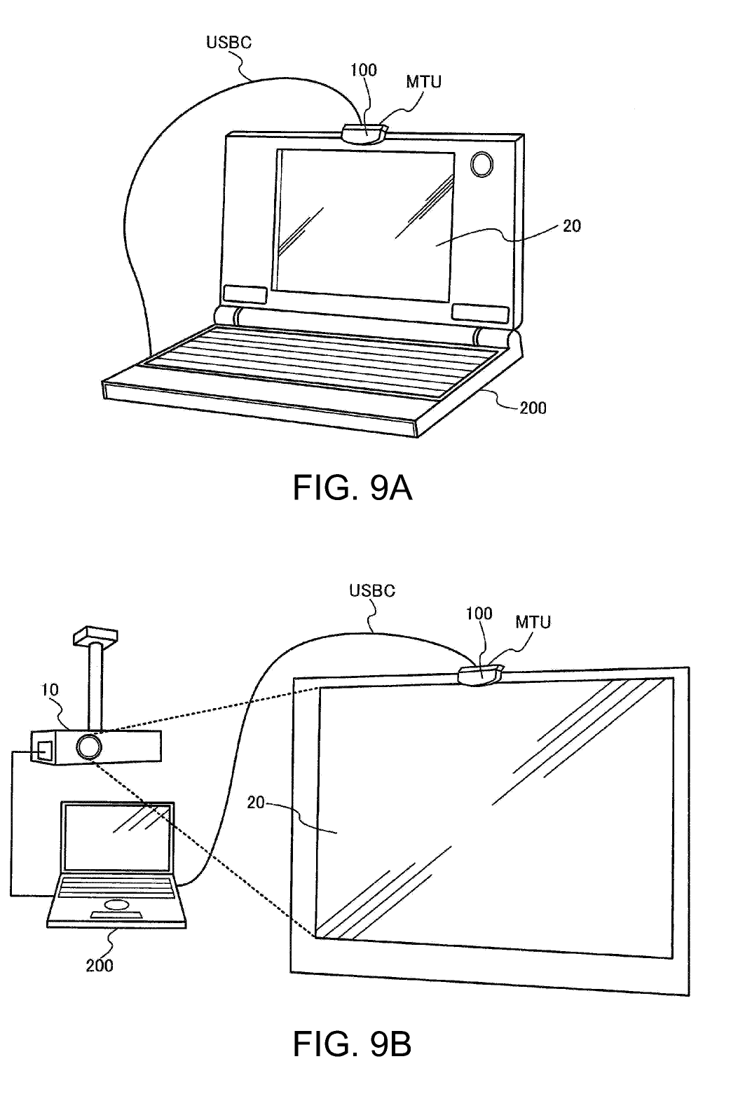

FIGS. 9A and 9B illustrate examples of a configuration of the optical detection system according to the present embodiment which is capable of being mounted to the information processing apparatus 200. The optical detection system shown in FIG. 9A includes a mounting section MTU and is mounted to the display (display section in a broad sense) 20 of the personal computer (information processing apparatus in a broad sense) 200 by the mounting section MTU. Further, the optical detection apparatus 100 and the personal computer 200 are electrically connected with each other through a USB cable USBC.

Electric power is supplied to the optical detection apparatus 100 from the personal computer 200 through the USB cable USBC. Further, through the USB cable USBC, the display instructing section 130 gives an instruction to display the calibration screen on the display section 20. Further, a computer program for the calibration process stored in the optical detection apparatus 100 can be transmitted to the information processing apparatus 200 through the USB cable USBC. Further, the Z coordinate information detected by the optical detection apparatus 100 can be transmitted to the information processing apparatus 200 through the USB cable USBC.

The optical detection system shown in FIG. 9B includes the mounting section MTU, and is mounted to the screen (display section in a broad sense) 20 by the mounting section MTU. An image is displayed on the screen 20 by an image projection apparatus 10 connected with the information processing apparatus 200. Further, the optical detection apparatus 100 and the information processing apparatus 200 are electrically connected with each other through a USB cable USBC. In this way, it is possible to perform the calibration process using the common optical detection system with respect to a broader display area.

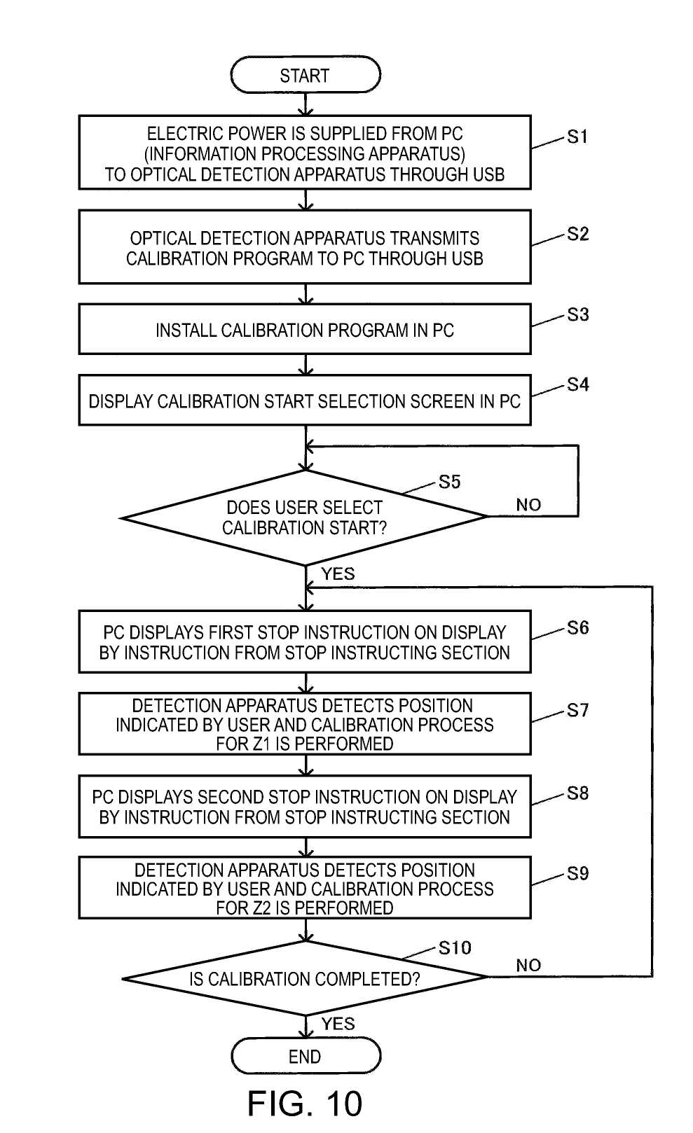

FIG. 10 illustrates an example of a flow diagram of the calibration process in the configuration examples in FIGS. 9A and 9B. The flow shown in FIG. 10 corresponds to a case where the information processing apparatus 200 (PC) performs the calibration process, but the calibrating section 120 (FIG. 1A) disposed in the optical detection apparatus 100 may perform the calibration process.

Firstly, the optical detection apparatus 100 is mounted to the display section 20 by the mounting section MTU. The information processing apparatus 200 (PC) and the optical detection apparatus 100 are connected with each other by the USB cable. Then, electric power is supplied to the optical detection apparatus 100 from the PC 200 through the USB cable (step S1).

Then, the calibration program is transmitted to the PC 200 from the optical detection apparatus 100 through the USB cable (step S2). In the PC 200, the calibration program is installed (step S3). The calibration program is stored in a computer readable memory, e.g., an optical disk such as a CD-ROM, a hard disk, or a storage medium such as a non-volatile storing device such as an EEPROM.

If the calibration program is executed in the PC 200, a calibration start selection screen is displayed on the display (or screen) 20 (step S4). Further, when a user selects to start the calibration process (step S5, YES), the first stop instruction is displayed on the display (or screen) 20 by the instruction from the stop instructing section 140 (step S6). Here, when the user does not select to start the calibration process (step S5, NO), a selection waiting status is continued.

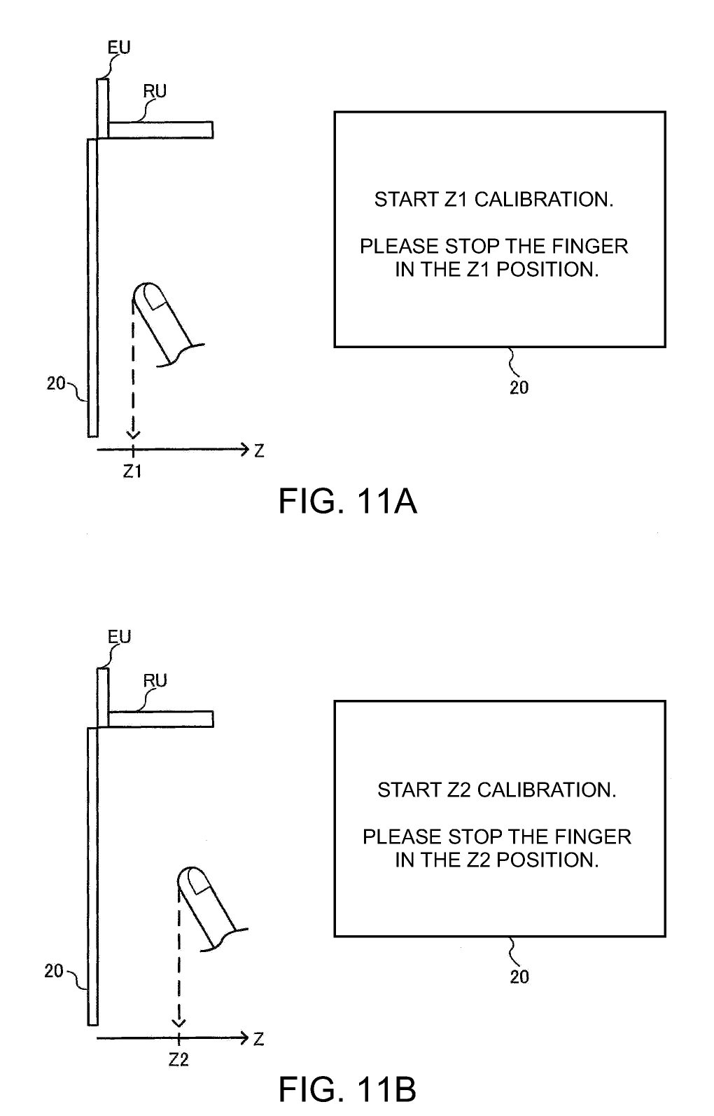

The first stop instruction in step S6 means that the user gives an instruction to stop the object (finger tip or pen) in a desired Z coordinate position for the calibration process relating to Z1. Specifically, as shown in FIG. 11A, an instruction “please stop the finger in the Z1 position” is displayed on the display 20.

Subsequently, the optical detection apparatus 100 detects the position instructed by the user using the finger tip, and the PC 200 performs the calibration process for Z1 on the basis of the detected Z coordinate information (step S7). As shown in FIG. 11A, the Z coordinate position of the finger tip is detected and the calibration process for Z1 is performed.

Then, the second stop instruction is displayed on the display (or screen) 20 by the instruction from the stop instructing section 140 (step S8). The second stop instruction means that the user gives an instruction to stop the object (finger tip or pen) in a desired Z coordinate position for the calibration process relating to Z2. Specifically, as shown in FIG. 11B, an instruction “please stop the finger in the Z2 position” is displayed on the display 20.

Subsequently, the optical detection apparatus 100 detects the position instructed by the user using the finger tip, and the PC 200 performs the calibration process for Z2 on the basis of the detected Z coordinate information (step S9). As shown in FIG. 11B, the Z coordinate position of the finger tip is detected and the calibration process for Z2 is performed.

Further, when the calibration process is completed (step S10, YES), the procedure is terminated. When the calibration process is not completed (step S10, NO), the procedure returns to step S6 and performs the calibration process again.

As described above, according to the optical detection system according to the present embodiment, it is possible to detect the Z coordinate information on the object and to match the Z coordinate information with the operation instruction information. In this way, by moving the finger tip, the user can give instructions such as a hovering operation or a fixed operation to the information processing apparatus. Further, since the calibration process for calibrating the threshold of the Z coordinate (Z1 and Z2) for determining whether the operation is the hovering operation or the fixed operation can be performed, it is possible to set the threshold of the Z coordinate so that the user can easily perform the operation.

Further, since it is possible to mount the optical detection system to the display section (display or screen) of an information processing apparatus, it is possible to give the operation instruction by the finger tip or pen by mounting the optical detection system in this embodiment to the display section without a touch panel function. Further, since the operation instruction can be given even though the finger tip is not in contact with the screen such as a touch panel, it is possible to prevent the screen from being smudged or damaged.

Further, since the threshold in the Z coordinate can be set by the calibration process in either case where the display area is large (projector screen) or small (display of a notebook PC), it is possible to cope with the display area using one optical detection system.

In the above description, the present embodiment is described in detail, but it will be understood to those skilled in the art that a variety of modifications can be made without substantially departing from the novelty and effects of the invention. These modifications should be construed to be included in the scope of the invention. Such variations are not to be regarded as a departure from the spirit and scope of the invention, and all such modifications are intended to be included within the scope of the claims. For example, a term which is used in the description or drawings at least once, together with a different term having a broader or equivalent meaning, can be replaced with the different term in any location of the description or drawings. Further, the configurations and operations of the optical detection system, the electronic device and the computer program are not limited to the above description of the present embodiment, but may be variously modified.

What is claimed is:

1. An optical detection system comprising:
a coordinate information detecting section that detects coordinate information of an object based on a light reception result of reflection light obtained by reflecting irradiation light from the object; and
a calibrating section that performs a calibration process for the coordinate information,
wherein the coordinate information detecting section detects at least Z coordinate information which is the coordinate information in a Z direction in a case where a detection area which is an area where the object is detected is set in a target surface along an X-Y plane, and
the calibrating section performs the calibration process for the Z coordinate information.

2. The optical detection system according to claim 1, wherein
the calibrating section performs the calibration process for the Z coordinate information based on the light reception result in a case where the object is in a Z coordinate range for calibration, at the time of calibration.

3. The optical detection system according to claim 2, wherein
in a case where a predetermined operation instruction is given in a period when the object is present in a predetermined Z coordinate range, the calibrating section performs the calibration process for the predetermined Z coordinate range corresponding to the predetermined operation instruction.

4. The optical detection system according to claim 3, wherein
the calibrating section performs the calibration process for a threshold in the Z coordinate range in a hovering operation.

5. The optical detection system according to claim 4, wherein
in a case where it is determined that a fixed operation is performed when a Z coordinate position of the object is equal to or less than Z1 (Z1 is a real number), and that the hovering operation is performed when the Z coordinate position of the object is larger than Z1 and is equal to or less than Z2 (Z2 is a real number satisfying Z2>Z1), the calibrating section performs the calibration process for the Z coordinate position Z1 and the Z coordinate position Z2.

6. The optical detection system according to claim 5, further comprising:
a stop instructing section which gives an instruction to stop the object in the Z coordinate position for calibration at the time of calibration,
wherein the calibrating section performs the calibration process after the stop instruction is given by the stop instructing section.

7. The optical detection system according to claim 6, wherein
the stop instructing section gives a first stop instruction for the calibration process for the Z coordinate position Z1 and gives a second stop instruction for the calibration process for the Z coordinate position Z2, and
the calibrating section performs the calibration process for the Z coordinate position Z1 after the first stop instruction is given and performs the calibration process for the Z coordinate position Z2 after the second stop instruction is given.

8. The optical detection system according to claim 1, further comprising:
a mounting section which causes the optical detection system to be mounted to an information processing apparatus,
wherein the calibrating section performs the calibration process as electric power is supplied from the information processing apparatus.

9. The optical detection system according to claim 8, wherein
the detection area is set along a display section of the information processing apparatus.

10. The optical detection system according to claim 9, further comprising a display instructing section which gives an instruction to display a calibration screen on the display section.

11. The optical detection system according to claim 1, further comprising:
a light irradiating section which emits the irradiation light to the detection area; and
a light receiving section which receives the reflection light.

12. The optical detection system according to claim 11, wherein
the light receiving section includes a plurality of light receiving units,
the light receiving units are arranged in positions having different heights in the Z direction, and
the coordinate information detecting section detects the Z coordinate information based on the light reception result of each of the light receiving units.

13. An electronic device comprising the optical detection system according to claim 1.

14. An electronic device comprising the optical detection system according to claim 2.

15. An electronic device comprising the optical detection system according to claim 3.

16. An electronic device comprising the optical detection system according to claim 4.

17. An electronic device comprising the optical detection system according to claim 5.

18. An electronic device comprising the optical detection system according to claim 6.

19. An electronic device comprising the optical detection system according to claim 7.

20. A computer readable memory storing a computer program executable by a processor for controlling an optical detection system, the computer program causing the processor to perform processing comprising:
a coordinate information detecting procedure that detects coordinate information of an object based on a light reception result of reflection light obtained by reflecting irradiation light from the object;
a calibrating procedure that performs a calibration process for the coordinate information; and
a stop instructing procedure that gives an instruction to stop the object in the Z coordinate position for calibration,
wherein the coordinate information detecting procedure detects at least Z coordinate information that is the coordinate information in a Z direction in a case where a detection area which is an area where the object is detected is set in a target surface along an X-Y plane, and
the calibrating procedure performs the calibration process for the Z coordinate information after the stop instruction is given by the stop instructing procedure.
